(19) United States
(12) Patent Application Publication
(10) Pub. No.: US 2014/0380399 A1
(43) Pub. Date: Dec. 25, 2014

(54) SYSTEM FOR REDUCING RETURN SIGNAL NOISE WITHOUT RADIO FREQUENCY SWITCHING DEVICES

(71) Applicant: David ZILBERBERG, Herut (IL)

(72) Inventor: David ZILBERBERG, Herut (IL)

(21) Appl. No.: 14/483,689

(22) Filed: Sep. 11, 2014

Related U.S. Application Data
(63) Continuation-in-part of application No. 13/144,210, filed on Jul. 12, 2011, now Pat. No. 8,850,505.
(60) Provisional application No. 61/211,732, filed on Apr. 1, 2009.

(51) Int. Cl. H04N 7/10; H04N 21/61

(52) U.S. Cl. CPC H04N 7/102; H04N 21/6168; H04N 7/104
USPC 725/125

(57) ABSTRACT

A bi-directional return signal noise reducing unit includes first and second ports, an amplifier, and a noise checking circuit. The first port connects to a cable television network. The second port connects to one or more devices of a subscriber to the cable television network. The amplifier includes an input that is connected to the second port and includes an output that is connected to the first port. The noise checking circuit samples the signals flowing from the second port to the first port. The noise checking circuit also: when a level of the signals flowing from the second port toward the first port are less than a predetermined threshold, blocks the signals from the input of the amplifier; and when the level of the signals flowing from the second port toward the first port are greater than the predetermined threshold, supplies the signals to the input of the amplifier.

### CROSS-REFERENCE TO RELATED APPLICATIONS

This application claims the benefit of and is a continuation-in-part of U.S. patent application Ser. No. 13/144,210 (now U.S. Pat. No. ______), filed Jul. 12, 2011; which is a 371 U.S. National Stage of International Application No. PCT/IL2010/000293, filed Apr. 6, 2010; which claims the benefit of U.S. Provisional Application No. 61/211,732, filed Apr. 1, 2009. The disclosures of the above applications are incorporated herein by reference.

### FIELD OF THE INVENTION

The present invention relates to systems and methods for signal noise reduction in comprehensive information networks. More specifically, the present invention relates to a system for reducing return signal noise in a CATV (cable television) without the use of radio frequency (RF) switching devices and a method thereof.

### BACKGROUND OF THE INVENTION

Cable modem technology is used in a widespread manner throughout the world. In general, the demand for CATV bandwidth and types of signals transmitted on CATV is increasing. Two-way CATV networks have been touted as a promising method of providing communication in the cable television system. However, technical problems have reduced performances of such two-way networks. In particular, interference of such two way network is an issue. More particularly, interference due to ingress radio frequency (RF) noise has greatly affected the quality of the return path communication. Return path communications are communications from subscribers to the head end facility.

Ingress signals comprise RF noise signals that are generated by sources external to CATV network and are radiated onto the CATV network through cable faults, terminations, and the like. Some sources of ingress include international short-wave broadcasts; citizens band and ham radio transmissions; television receivers; computers; neon signs, electrical motors, hair dryers, garbage disposals, and other household appliances, and it has been estimated that 95% of ingress signal power originated in subscribers' homes.

Ingress signals are particularly troublesome in the context of the return path communication because of the CATV two way network structural designs. In a CATV network, a large number of subscribers' generated signals are funneled toward the head end. The ingress signal power on each of the subscribers' generated signals in therefor combined and amplified, resulting in relatively high ingress signal power at the head end facility.

Several approaches know in the Art for signal noise reductions in electrical system are provided using RF electronic switch and RF relay, which has mainly drawbacks of generating high frequencies RF noise and longtime delay using a relay.

### BRIEF SUMMARY OF THE INVENTION

In a feature, a bi-directional return signal noise reducing unit is disclosed. A first port connects to a cable television network. A second port connects to one or more devices of a subscriber to the cable television network. An amplifier includes an input that is connected to the second port and includes an output that is connected to the first port. A noise checking circuit samples the signals flowing from the second port to the first port. The noise checking circuit also: when a level of the signals flowing from the second port toward the first port are less than a predetermined threshold, blocks the signals from the input of the amplifier; and when the level of the signals flowing from the second port toward the first port are greater than the predetermined threshold, supplies the signals to the input of the amplifier.

In further features, the bi-directional return signal noise reducing unit is connected serially to a coaxial cable that is connected between a port of a coupler, splitter, or tap of the cable television network.

In further features, the bi-directional return signal noise reducing unit is installed outside of the premises of the subscriber between the premises and a port of a coupler, splitter, or tap of the cable television network.

In further features, a low pass filter connected between the second port and the input of the amplifier.

In further features, an alternating current (AC) to direct current (DC) converter for receiving AC power via a coaxial cable of the cable television network and converting the AC power into DC power for powering the bi-directional return signal noise reducing unit.

In further features, a splitter that is connected to the second port and to multiple output ports.

In further features, the bi-directional return signal noise reducing unit does not include any radio frequency (RF) switches or RF relays.

In further features, a splitter includes an input for connection to the to the cable television network and including first and second outputs, the first output connected to the first port of the bi-directional return signal noise reducing unit and the second output for connection to a component of the cable television network via a coaxial cable.

In further features, a high pass filter that filters signals flowing from the first port to the second port.

In a feature, a method of reducing return signal noise is disclosed. The method includes sampling signals flowing from a second port to a first port, wherein: the first port is for connection to a cable television network; the second port is for connection to one or more devices of a subscriber to the cable television network; and an amplifier includes an input that is connected to the second port and includes an output that is connected to the first port. The method further includes, using a noise checking circuit: when a level of the signals flowing from the second port toward the first port are less than a predetermined threshold, blocking the signals from the input of the amplifier; and, when the level of the signals flowing from the second port toward the first port are greater than the predetermined threshold, supplying the signals to the input of the amplifier.

### BRIEF DESCRIPTION OF THE DRAWINGS

FIG. 1 (PRIOR ART) is a block diagram illustration of a typical two-way amplifier circuit;

FIG. 2 is a block diagram of a new bi-directional cable TV drop (home) amplifier circuit with a noise checking circuit;

FIG. 3 is a block diagram of a hybrid fiber coax (HFC) cable TV network configuration;

FIG. 4 is a block diagram of a new bi-directional cable TV drop (Home) amplifier circuit with a noise checking circuit;

FIG. 5 is a diagram of an example unit and housing configuration for reducing noise in a CATV return signal;

FIGS. 6 and 7 are block diagrams of new cable TV network configurations using the unit for reducing noise in the CATV return signal;

FIGS. 8-10 are schematics of new systems including example electronic circuit configurations for reducing noise in the CATV return signal.

### DETAILED DESCRIPTION OF THE INVENTION

As mentioned earlier, comprehensive information networks are characterized as 2-way transmission systems having information flow to the head-ends via terminal interchanges and relays.

Transmission from head-end to terminal is “Forward” or “Downstream,” and transmission from terminal to head-end is “Return” or “Upstream”. A signal going downstream is a point-to-interface “broadcasting”, and is split; signals going upstream are interface-to-point converged. Either “broadcasting” or “converging” are conducted by splitters.

In the upstream path, upstream signals are combined with noise coming from various paths. Eventually, all noises are funneled to the head-end, the so called “Funnel Effect”. However, some of the noise components may have a high enough energy to mask the return signals, thus, may seriously affect the quality of the “Return” transmission.

Such noise components mostly come from terminals such as a cable modem where the commonly used amplifiers are one of the major noise generators.

Cable modems are not continuously transmitting to the return path. Thus, if the return path of the amplifier may be blocked at times when the cable modem stops transmitting to the return path, the noise coming from the subscriber premises may be significantly reduced, and so too the “Funnel Effect”.

In addition to solving the “Funnel Effect”, the system and method of the present invention has the following advantages. Firstly, the system is capable of achieving about 90% noise reduction and provides up to 35 dB return noise isolation. Secondly, the system's operating system is based on the burst nature of the cable modem's return path transmission and is capable of solving and blocking all ingress noise coming from customers' premises. Thirdly, the system does not require RF (radio frequency) switches or relays and, therefore, avoids the high frequency noise generation associated with operating RF switches and relays. Fourthly, the proposed system involves relatively low cost since (a) it is based on low cost bi-directional cable TV drop (home) amplifier components and (b) it may be implemented on a cable TV network at various locations and can be powered via alternating current (AC) voltage at a coaxial network or via a power adaptor at a customer's premises.

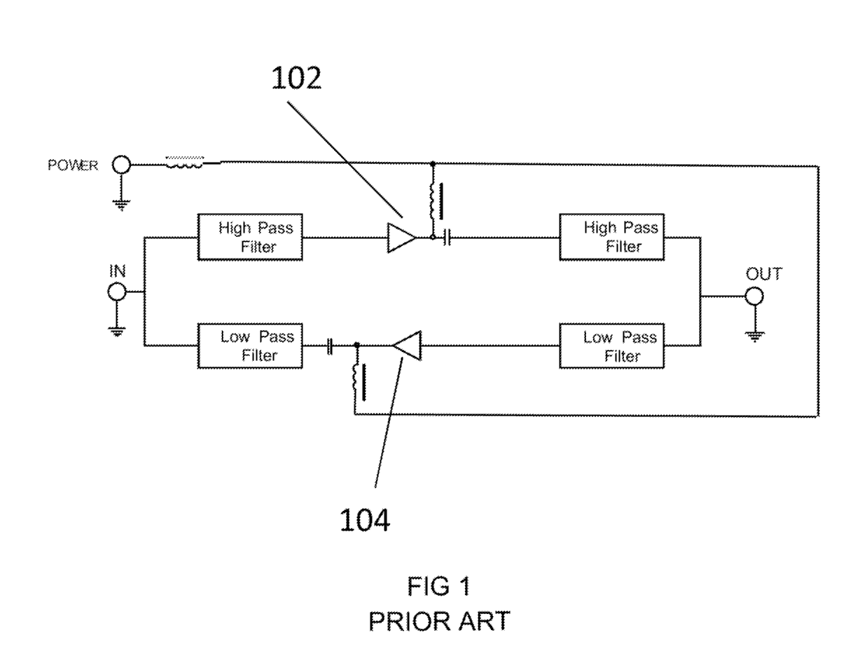

FIG. 1 (PRIOR ART) is a block diagram of a typical two-way amplifier circuit. In this circuit, both internal amplifiers, i.e., amplifier 102 and amplifier 104, are always active.

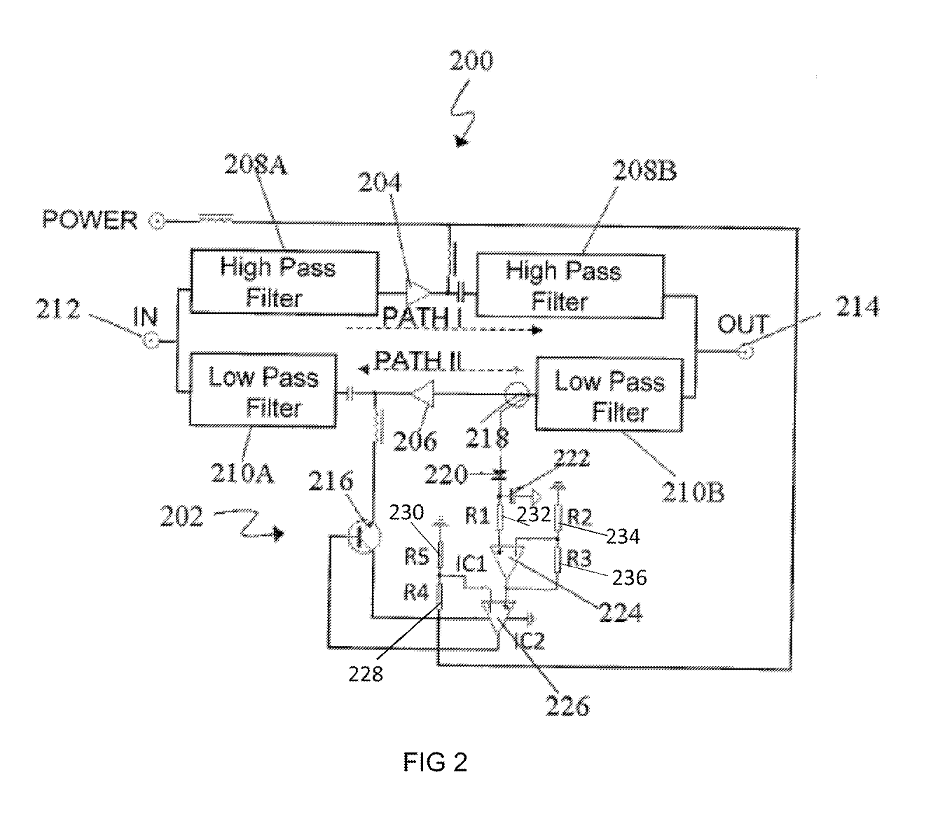

FIG. 2 is a block diagram of a new bi-directional cable TV drop (home) amplifier circuit 200 with a noise checking circuit 202. As seen in FIG. 2, the bi-directional cable TV drop (home) amplifier circuit 200 comprises a forward (or downstream) amplifier part 204 along forward PATH I and a return (or upstream) amplifier part 206 along upstream PATH II depicted by corresponding arrow lines.

PATH I and PATH II are isolated by High Pass Filter (HPF) 208A & B and by Low Pass Filter (LPF) 210A & B respectively.

Forward (or downstream) signals enter at the IN port 212, pass through HPF 208A get amplified in forward amplifier part 204, pass through HPF 208B and exit through OUT port 214. Return (or upstream) signals enter at the OUT port 214, pass through LPF 210B, get amplified in return amplifier part 206, pass through LPF 210A, and exit through IN port 212.

Return signal noise checking circuit 202 comprises an electronic circuit block/unblock PATH2 that supplies or disables voltage to the return amplifier part 206 depending on whether the level of return signal (from customer premises) is above/below a predefined threshold such as for, instance 80 dB□V for an un-modulated signal. The return signal noise checking circuit 202 disables voltage to the return amplifier part 206 when the level of the return signal (from the customer premises) is less than the predefined threshold and supplies voltage to the return amplifier part 206 when the level of the return signal (from the customer premises) is greater than the predefined threshold.

The bi-directional cable TV drop (home) amplifier circuit 200 comprises a joint 218 along PATH 2, a diode 220, a capacitor 222, a comparator 224, a comparator 226, and resistors 228-236. The return signal is sampled at joint 218 and passed through diode 220. Output from diode 220 forms a signal voltage at the capacitor 222, which is equivalent to the DC voltage to the level of the return signal path (Path 2). The sample DC voltage gets amplified by comparator 224 and then enters into comparator 226.

When the return signal passing through PATH 2 has a return signal level greater than a predefined threshold, comparator 226 outputs voltage to turn transistor 216 to saturation and enables DC voltage to return amplifier part 206. In other words, when the return signal passing through PATH 2 has a signal level greater than a predefined threshold, comparator 224 outputs a high voltage and comparator 226 powers the return amplifier part 206 and enables the return signal to pass through PATH 2 to head-end, i.e., to IN port 212. In this case, the performance of new bi-directional cable TV drop (home) amplifier circuit 200 is the same as of the two-way amplifier as illustrated in FIG. 1.

However, when the level of the return signal passing though PATH 2 is lower than the predefined threshold, the comparator 226 outputs a relatively low voltage, the transistor 216 turns off the voltage (input) to the return amplifier part 206 and blocks the return signal at PATH 2 toward the head-end. When PATH 2 is blocked, the return signal noise which flows from the premises through PATH is decreased significantly.

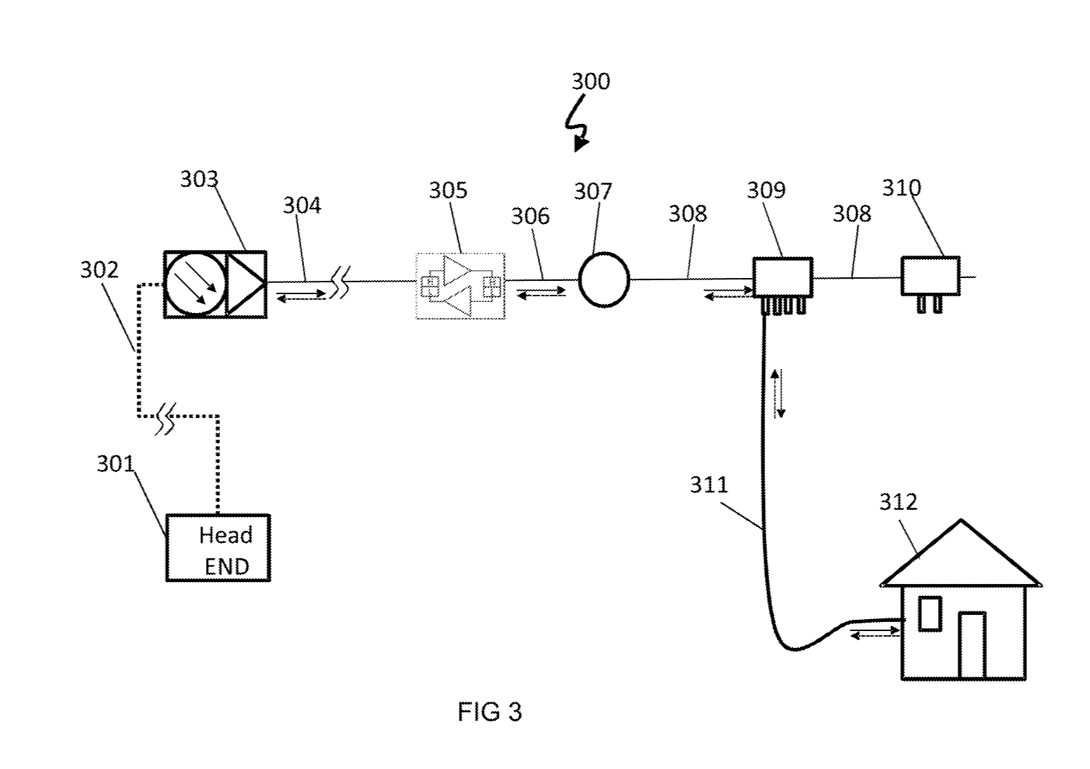

FIG. 3 is a block diagram of a hybrid fiber coax (HFC) cable TV network configuration 300. Head-end 301 is the broadcast center transmitting forward optical signals to and receiving return optical signals from the premises TV appliances & cable modems.

Optical cable 302 is connected to and delivers data from/to the Head-end 301 to the Optical node 303. Optical node 303 converts optical data to radio frequency (RF) transmission and transmits that RF signal to line amplifier 305 via trunk coaxial cable 304. Additionally, optical node 303 converts return RF signals received to optical signals and transmits the return optical signals toward the head-end 301 via optical cable 302.

Line amplifier 305 output continues distributing RF signals via trunk coaxial cable 306 and splitter/coupler 307. From splitter/coupler 307, RF signals continue distributing to splitter and tap 309 and 310 via coaxial cables collectively illustrated by 308.

The RF signal from Tap 309 is distributed to building & the premises area 312 via drop coaxial cable 311.

In addition, at the bi-directional cable TV network return RF signal at the low frequency transmitted from premises area 312 to the head-end 301 in the opposite direction via drop cable 311, tap 309, splitter/coupler 307, coaxial cable 308, trunk cable 304, line amplifier 305, and optical cable 302.

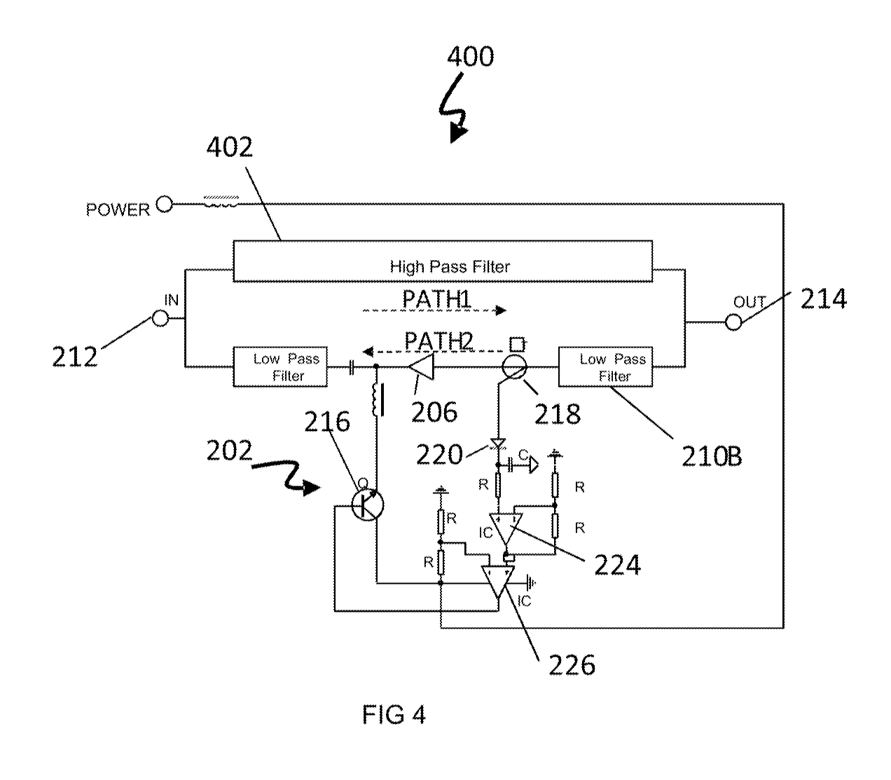

FIG. 4 is a block diagram of new bi-directional cable TV drop (Home) amplifier circuit 400 with a noise checking circuit 202. As seen in FIG. 4, new bi-directional cable TV drop (home) amplifier circuit 400 comprises a High Pass filter 402, forward path 1, and return PATH 2 depicted by corresponding arrow lines.

PATH 1 and PATH2 are isolated by High Pass Filter (HPF) 402 and by Low Pass Filter (LPF) 210A & B, respectively.

Forward signals enter at the IN port 212, pass through the HPF 302 and exit through OUT port 214. Different, return signals enter at the OUT port 214 pass through LPF 210B, get amplified in return amplifier part 206, pass through LPF 210A, and exit through IN port 212.

Return signal noise checking circuit 202 comprises an electronic circuit block/unblock PATH2 via supplying/disable voltage to the return amplifier part 206 when the level of return signal (from customer premises) is above/below a predefined threshold such as for, instance 80 dB□V for an un-modulated signal.

Signal noise checking circuit 202 further comprises a joint 218 along PATH 2, a diode 220, a capacitor 222, a comparator 224, a comparator 226, and resistors 228-236. The return signal is sampled at joint 218 and passed through diode 220. Output from diode 220 forms a signal voltage at the capacitor 222, which is equivalent to the DC voltage to the level of the return signal path (Path 2). The sample DC voltage gets amplified by comparator 224 and then enters into comparator 226.

When the return signal passing through PATH 2 has a return signal level greater than a predefined threshold, comparator 226 outputs voltage to turn transistor 216 to saturation and enables DC voltage to return amplifier part 206. In other words, when the return signal passing through PATH 2 has a signal level greater than a predefined threshold, comparator 224 outputs a high voltage and comparator 226 saturates transistor 216 and enables the return signal to pass through PATH 2 to head-end, i.e., to IN port 212. In this case (i.e., when the return signal is greater than the predefined threshold), the performance of new bi-directional cable TV drop (home) amplifier circuit 200 is the same as a return amplifier & passive forward.

However, when the level of the return signal passing though PATH 2 is lower than the predefined threshold, the comparator 226 outputs a relatively low voltage, the transistor 216 turns off and stops the voltage (input) to the return amplifier part 206 and therefore blocks the return signal at PATH 2 to the head-end 301. When PATH 2 is blocked, the return signal noise which flows from the premises through PATH is decreased significantly.

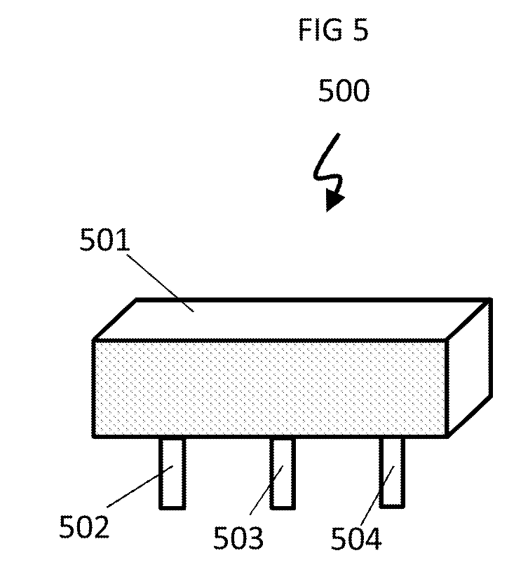

FIG. 5 is a diagram of an example unit 500 and housing configuration for reducing noise in the CATV return signal. The unit 500 and housing provide one modular component.

Unit 500 includes 3 ports 502, 503, and 504. Unit 500 also includes housing 501. Port 502 is the input port for connecting to the cable TV network side. Port 503 is an output port for connecting to the premises area at the side of the end user. Port 504 is a power input port to enable the unit 500 to receive power from an external DC (direct current) source.

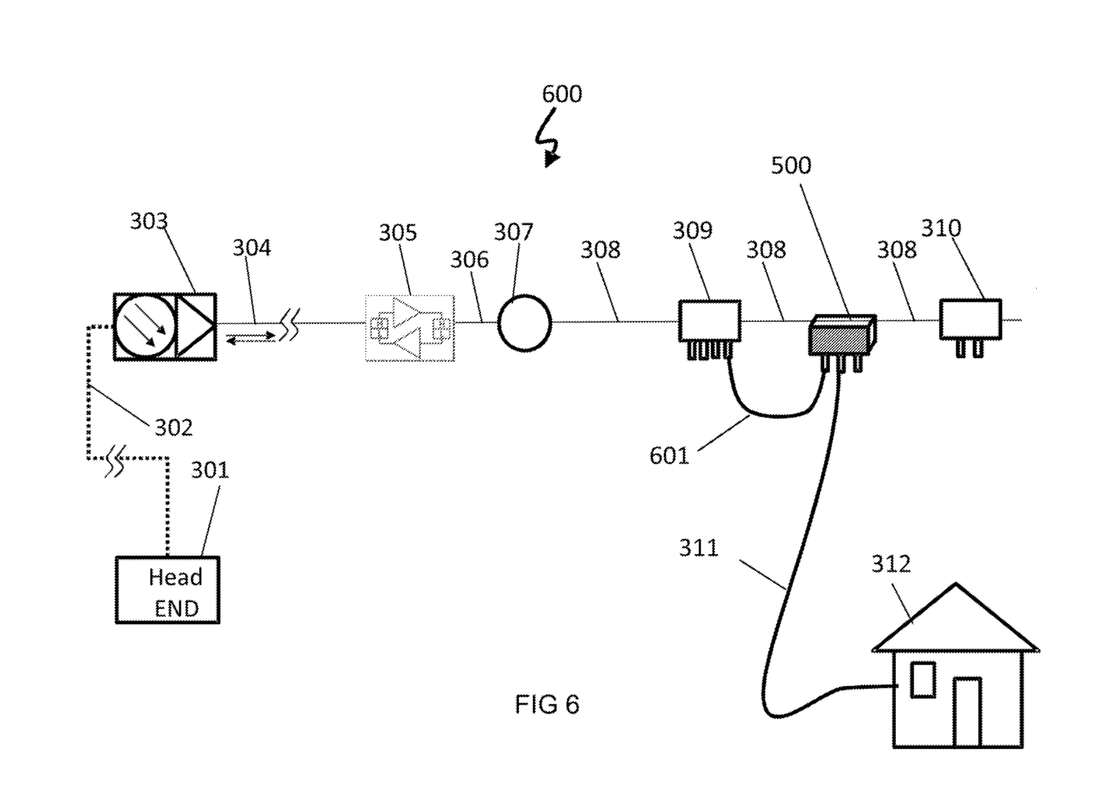

FIG. 6 is a block diagram of a new cable TV network configuration 600 using the unit 500 for reducing noise in the CATV return signal. Head-end 301 is the broadcast center transmitting forward optical signals to and receiving return optical signal from the premises TV appliances & cable modems.

Optical cable 302 is connected to and delivers data from/to the Head-end 301 to the Optical node 303. Optical node 303 converts optical data to radio frequency (RF) transmission and transmits that RF signal to line amplifier 305 via trunk coaxial cable 304. Additionally, optical node 303 converts return RF signals received to optical signals and transmits the return optical signals toward the head-end 301 via optical cable 302.

Line amplifier 305 output continues distributing RF signals via trunk coaxial cable 306 and splitter/coupler 307. From splitter/coupler 307, RF signals continue distributing to splitter and tap 309 & 310.

The RF signal from Tap 309 is connected to unit 500 for reducing return noise via coaxial cable 601. The unit 500 distributes RF signals to the building/premises 312 via drop coaxial cable 311. The unit 500 also transmits return signals from the premises 312 back the head-end 301 via the tap 309, the splitter/coupler 307, the line amplifier 305, the trunk cable 304, the optical node 303, and the optical cable 302. As described above, the unit 500 reduces noise in the return signals.

In this example, the unit 500 can receive DC power without using output port 503 or via an external DC power source and the DC port 504.

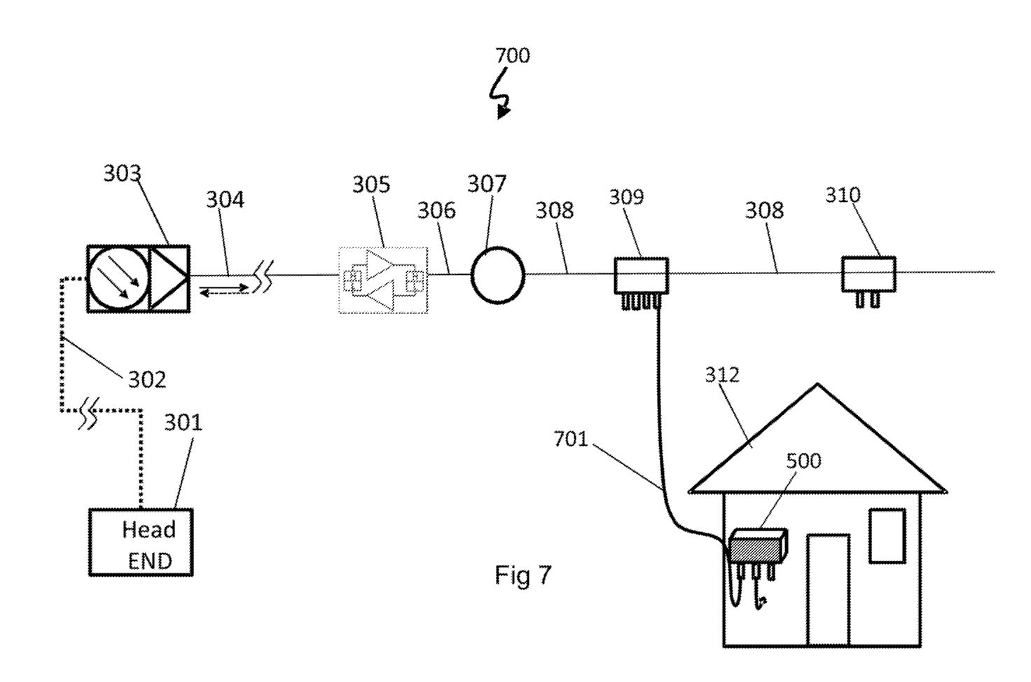

FIG. 7 is a block diagram of a new HFC cable TV network configuration 700 using the unit 500 for reducing noise in the CATV return signal and is installed outside of the premises/building 312. In this case, the unit 500 receives RF signals from the tap 309 via the coaxial drop cable 701 and distributes signals to the premises building 312. The unit 500 also transmits return signals toward the head-end 301 via the drop cable 701.

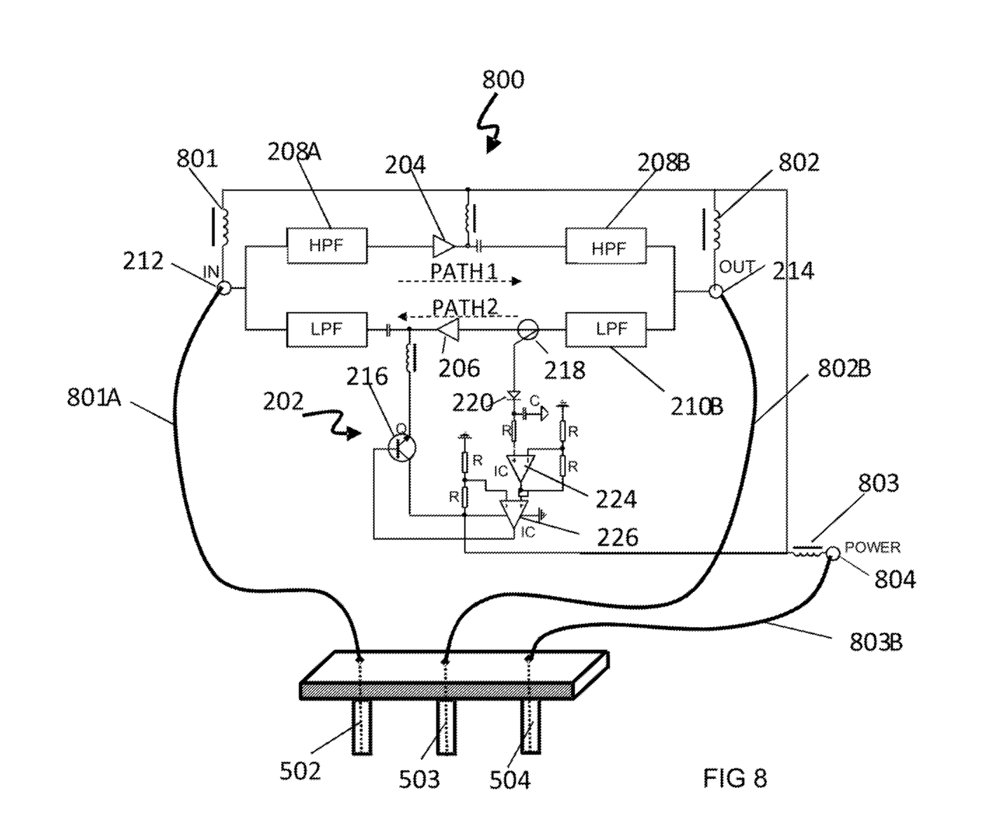

FIG. 8 is a schematic of a new system 800 for reducing noise in the CATV return signal with three powering options: from external port 502 via coax cable 801A toward input port 212 via coil 801 (DC pass filter); from external port 503 via coaxial cable 802B toward output port 214 via coil 802; and via port 504 through cable 803B and coil (DC pass filter) 803.

A DC line 803B is connected to internal port 212 via coil(DC pass filter) 801. DC line 804 is also connected to internal port 214 via coil 802 (DC pass filter) 803B.

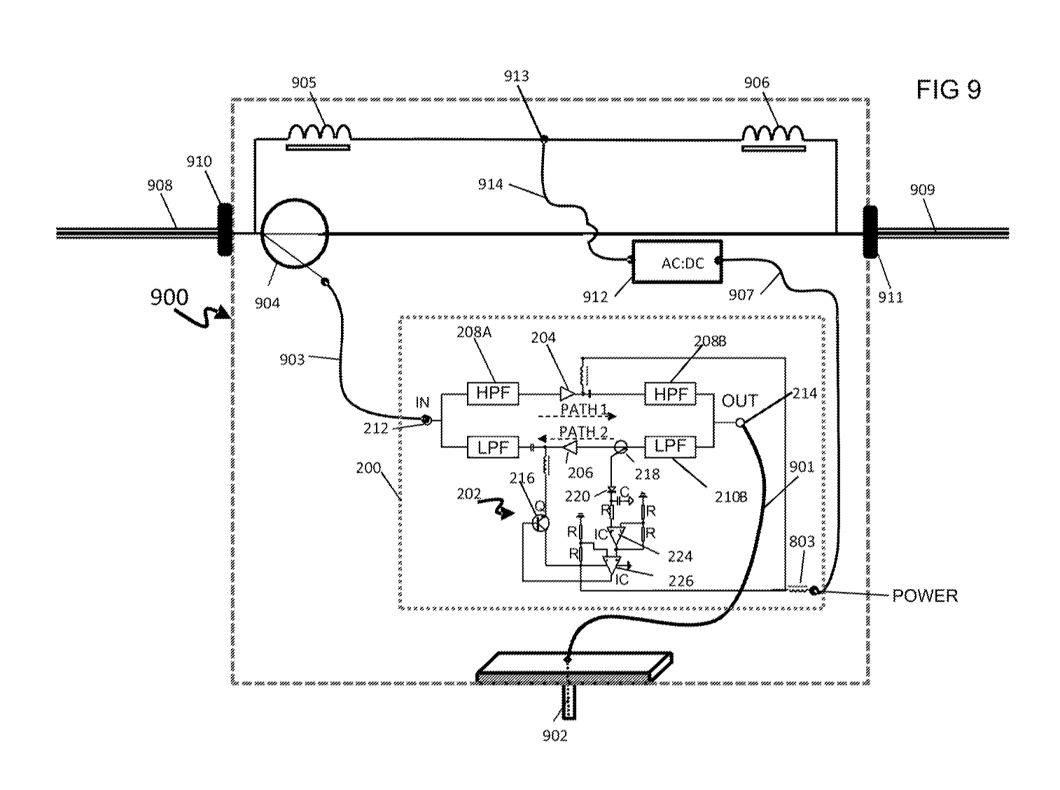

FIG. 9 is a schematic of a configuration of a bi-directional return signal noise reducing unit 900 with an additional joint/coupler to the coaxial trunk cable to provide bi-directional RF output to/from a premises/building. Trunk coaxial cable 908 is connected to joint (coupler) unit 900 through port 910.

An internal joint/coupler 904 splits the signal to port 911, which is connected to trunk coaxial cable 909. First and second coils 905 and 906 act as LPFs and isolate the AC voltage from ports 910 and 911. An AC joint 913 between the first and second coils 905 and 906 is connected to AC to DC converter 912 via connector 914. The AC to DC converter 912 supplies DC power through cable 907 to the circuit 200 for reducing noise in the CATV return signal. A second output of joint/coupler 904 is connected to the internal input port 212 of circuit 200 through cable 903. The internal output port 214 of circuit 200 is connected to output port 902 of the joint/coupler unit 900.

This configuration enables direct connection to a trunk coaxial cable and supplies power to the circuit 200 for reducing noise in the CATV return signal from AC voltage available on the trunk coaxial cable without the need for an external power source. This configuration also enables blocking of the return RF noise, and the unit can be installed on utility side of a cable TV network, outside of the customer premises/building. This configuration also provides one output tap 902 to connect the premises area to cable TV network.

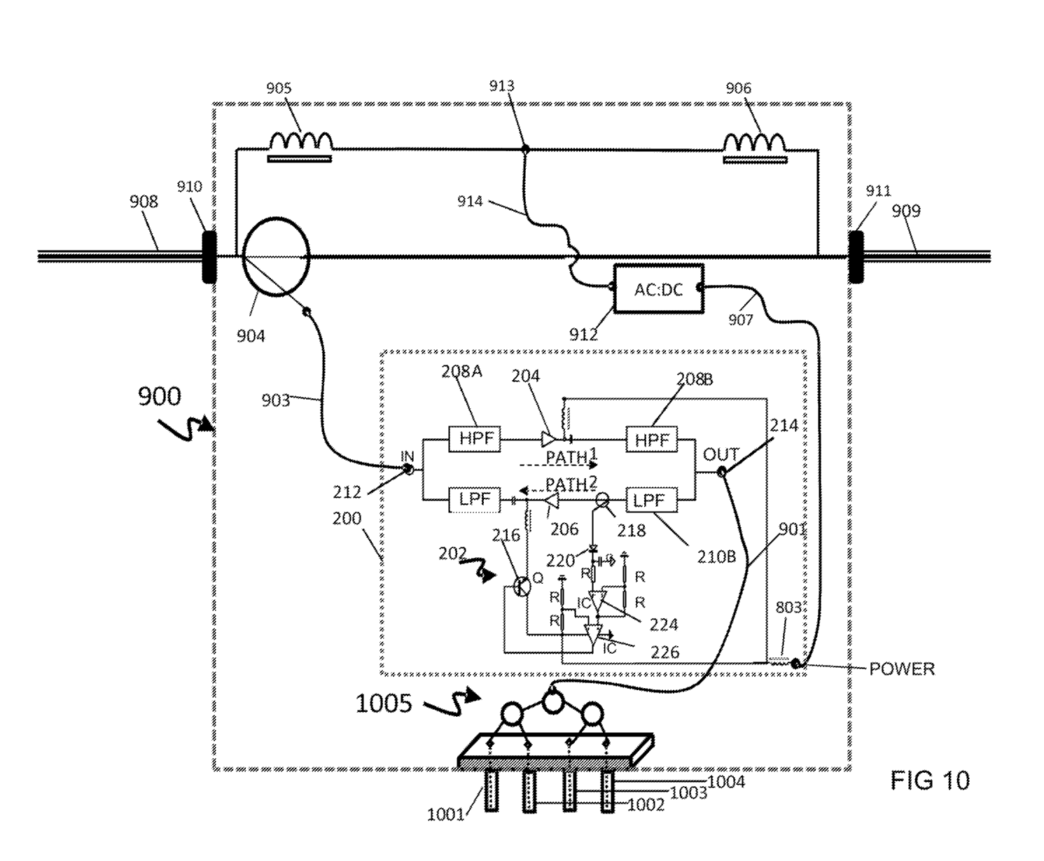

FIG. 10 is a schematic of a configuration of a bi-directional return signal noise reducing unit 1000 with an additional joint/coupler to the coaxial trunk cable to provide bi-directional RF output to/from a premises/building. In FIG. 10, trunk coaxial cable 908 is connected to joint (coupler) unit 900 through input port 910. A joint/coupler 904 splits the signal to port 911, which is connected to trunk coaxial cable 909. First and second coils 905 and 906 act as LPFs and isolate the AC voltage from ports 910 and 911. An AC joint 913 between the first and second coils 905 and 906 is connected to AC to DC converter 912 via connector 914. The AC to DC converter 912 supplies DC power through connector 907 to the circuit 200 for reducing noise in the CATV return signal. A second output of joint/coupler 904 is connected to the internal input port 212 of circuit 200 through cable 903.

The internal output port 214 of circuit 200 is connected to multiple output taps, such as outputs taps 1001, 1002, 1003, and 1004 via one or more internal, multi-way RF splitters 1005. While the example of 4 output taps and 3 different two way splitters is shown and discussed, the present application is also applicable to 2, 3, and more than 4 output tap configurations and implementations involving different combinations of one or more multi-way splitters. A similar configuration can be made for all numbers of RF Tap outputs needed by changing the RF splitter configuration.

This configuration enables direct connection to a trunk coaxial cable and supplies power to the circuit 200 for reducing noise in the CATV return signal from AC voltage available on the trunk coaxial cable without the need for an external power source. This configuration also enables blocking of the return RF noise, and the unit can be installed on utility side of a cable TV network, outside of the customer premises/building. This configuration also provides multiple output taps to connect the premises area to cable TV network.

It should be noted that the amplifiers in either the forward path and/or the reverse/return path may be combined with passive network devices such as splitters (indoor or outdoor type splitter). It should be further noted that the forward path may be an active path as described above as well as a passive path.

What is claimed is:

1. A bi-directional return signal noise reducing unit comprising:
a first port for connection to a cable television network;
a second port for connection to one or more devices of a subscriber to the cable television network;
an amplifier that includes an input that is connected to the second port and that includes an output that is connected to the first port; and
a noise checking circuit that samples the signals flowing from the second port to the first port and that:
when a level of the signals flowing from the second port toward the first port are less than a predetermined threshold, blocks the signals from the input of the amplifier; and
when the level of the signals flowing from the second port toward the first port are greater than the predetermined threshold, supplies the signals to the input of the amplifier.

2. The bi-directional return signal noise reducing unit of claim 1, wherein the bi-directional return signal noise reducing unit is connected serially to a coaxial cable that is connected between a port of a coupler, splitter, or tap of the cable television network.

3. The bi-directional return signal noise reducing unit of claim 1, wherein the bi-directional return signal noise reducing unit is installed outside of the premises of the subscriber between the premises and a port of a coupler, splitter, or tap of the cable television network.

4. The bi-directional return signal noise reducing unit of claim 1 further comprising a low pass filter connected between the second port and the input of the amplifier.

5. The bi-directional return signal noise reducing unit of claim 1 further comprising an alternating current (AC) to direct current (DC) converter for receiving AC power via a coaxial cable of the cable television network and converting the AC power into DC power for powering the bi-directional return signal noise reducing unit.

6. The bi-directional return signal noise reducing unit of claim 1 further comprising a splitter that is connected to the second port and to multiple output ports.

7. The bi-directional return signal noise reducing unit of claim 1 wherein the bi-directional return signal noise reducing unit does not include any radio frequency (RF) switches or RF relays.

8. The bi-directional return signal noise reducing unit of claim 1 further comprising a splitter including an input for connection to the to the cable television network and including first and second outputs, the first output connected to the first port of the bi-directional return signal noise reducing unit and the second output for connection to a component of the cable television network via a coaxial cable.

9. The bi-directional return signal noise reducing unit of claim 1 further comprising a high pass filter that filters signals flowing from the first port to the second port.

10. A method of reducing return signal noise, the method comprising:
sampling signals flowing from a second port to a first port,
wherein:
the first port is for connection to a cable television network;
the second port is for connection to one or more devices of a subscriber to the cable television network; and
an amplifier includes an input that is connected to the second port and includes an output that is connected to the first port; and,
using a noise checking circuit:
when a level of the signals flowing from the second port toward the first port are less than a predetermined threshold, blocking the signals from the input of the amplifier; and
when the level of the signals flowing from the second port toward the first port are greater than the predetermined threshold, supplying the signals to the input of the amplifier.
